(19) United States
(12) Patent Application Publication
(10) Pub. No.: US 2005/0246405 A1
(43) Pub. Date: Nov. 3, 2005

(54) Mathematical transform function to calculate work and energy using newton's second low of motion and the work-energy theorem

(76) Inventor: Brette Angelo Pepe Delahoussaye, N. Hollywood, CA (US)

Correspondence Address: Brette de la Houssaye, 7719 Goodland Ave, North Hollywood, CA, 91605, US

(21) Appl. No.: 10/834,963

(22) Filed: Apr. 30, 2004

(51) Int. Cl. G06F 7/38

(52) U.S. Cl. 708/444

(57) ABSTRACT

Mathematical transform function to calculate work and energy using Newton's Second Law of Motion and the Work-Energy Theorem uses a mathematical transform function, with polynominal or fourier series as input, including an array table of proportionality constants that are rational numbers, specified to sixteen or more decimal places, to calculate the work and energy, or the integral area, for a force function or combination of any two polynominal functions. The integral area can be the result of the net integrand function as a function of the specified differential, or the integral area can be some combination of the vector components, which constitute the integrand, as a function of the specified differential.

### REFERENCE TO COMPUTER PROGRAM LISTING COMPACT DISC APPENDIX

Program entitled ‘Calcgate’ is included with patent application submission. Program Calcgate (CALCulus Geometric Area Transform Equation) uses mathematical transform function, including a table array of proportionality constants specified to sixteen decimal places, to calculate work and energy or the integral area, with polynominal or fourier series input, and is designed to run within the Matlab computing enviroment.

### BACKGROUND OF THE INVENTION

The kinetic or potential energy of an object or particle can be calculated using Newton's second law of motion and the work-energy theorem. A mathematical transform function can be used in order to arrive at the expression for work W=(½)*m*v²(tf), in units of joules j, equal to the area under the curve for a resultant constant force F, or time-varying force f(t), in units of newtons n, as it varies over a distance Δx, in units of meters, i.e., ∫F(x)dx or ∫f(x)dx. The force f(x), that does work on an object or particle of mass m, in units of kilograms kg, equals the object or particle's mass m, multiplied by it's acceleration a, or f=m*a. An alternate method to calculate the kinetic ΔK and potential ΔU energies, utillizes a mathematical transform function in order to determine the area under the curve for a force k(x), as a function of time, where both the force f(x), that does work on an object or particle, and the change in distance Δx, are expressed as equivalent functions of time, i.e., f(t) and Δx(t). The resulting area under the curve for a force function f(t), as it varies over a distance Δx(t), as determined using the transform function, exactly equals (½)*m*v²(tf), on any limits of integration of xi=0 and xf, in the corresponding time-interval ti=0 to tf, equal to Δt. The time-intervals referenced in the following examples are taken as proper time, i.e., time that is referenced in conjunction with the moving object or particle. In addition, the relative velocity should be much less than the velocity of light. Before explaining the transform function, an expression for work W=(½)*m*v²(tf), will be derived using newton's second law of motion, and the chain rule for derivatives. The work done W, on an object or particle is defined as the area under the curve for a force (fx), as it varies over distance Δx, as given in Eq. (1.0):
W=∫f(x)dx=∫m*adx Eq. (1.0)
f(x) in the above Eq. (1.0), is a resultant force that does work W, on an object or particle, along an x axis, in an inertial frame, i.e., a frame of reference without any other external forces. By substituting for the acceleration a, in the above Eq. (1.0), an equivalent expression using the chain rule or a=dv/dt=(dv/dx)*(dx/dt)=v*dv/dx, we have the following in Eq. (2.0):

$$\begin{matrix}W = \int f ( x ) ⅆ x \\ = \int m * a ⅆ x \\ = \int m * ( v * \frac{ⅆ v}{ⅆ x} ) * ⅆ x \\ = \int m * v * ⅆ v \\ = \frac{1}{2} * m * {v}^{2} ( tf ) - \frac{1}{2} * m * {v}^{2} ( t i )\end{matrix} \qquad Eq . ( 2.0 )$$

Eq. (2.0) equals the work done W=(½)*m*v²(tf) and change in kinetic energy ΔK, of an object or particle, due to a resultant force f(x), that does work along the x axis.

### DETAILED DESCPRIPTION OF THE INVENTION

The mathematical transform function uses the same formula in addition to utillizing both the force f(x) and displacement Δx, as equivalent functions of time, i.e., f(t) and Δx(tf), in order to calculate the work W=(½)*v²(tf), and change in kinetic energy ΔK, of an object or particle, on a limits of integration of xi=0 and xf, in the corresponding time-interval ti=0 to tf, equal to Δt. Specifically, the area under the curve for a force f(x), as it varies over a distance Δx, as an example when the force is constant F, or a single-term polynominal, f(t)=t, f(t)=t², . . . etc., can be calculated using the time-average of the force f(t)av=(1/Δt)*∫f(t)dt, the displacement Δx(tf), also expressed as an equivalent function of time Δx(tf)=∫[∫(f(t)/m)dt]dt, and a proportionality constant ∝=f(x)av/fx(t)av, like that shown in Eq. (3.0):
W=∫f(x)dx=∝*f(t)av*Δx(tf) Eq. (3.0)

In Eq. (3.0), second right-hand expression, the work W=(½)*m*v²(tf) and change in kinetic energy ΔK, determined on a limits of integration xi=0 and xf, in the corresponding time-interval ti=0 to tf, equal to Δt, equals the product of a proportionality constants ∝=f(x)av/f(t)av, and the time-average of the force f(t)av=(1/Δt)*∫f(t)dt, multiplied by the change in distance Δx(tf)=∫[∫(f(t)/m)dt]dt. The transform function requires that the limits of integration xi and xf and the corresponding time-interval ti to tf, equal to Δt, be such that both the initial distance xi and time ti, be set equal to zero. The preceeding conditions will be explained further in the examples that follow. The change in distance Δx(tt)=xf−xi, in Eq. (3.0), equals ∫[∫(f(t)/m)dt]dt, which is the integral of the velocity v(t)=∫(f(t)/m)dt, in a corresponding time-interval ti to tf, again where both ti and xi, are equal to zero. The proportionality constant ∝, in Eq. (3.0), equals the ratio of the average force f(x)av (in terms of distance), that does work W, on an object or particle, to that of the time-average of the force f(t)av (in terms of time), or ∝=f(x)av/f(t)av, and if the force F is constant then, the ratio ∝=F(x)av/F(t)av is equal to unity=1. Multiplying both the numerator and denominator by Δt, in Eq. (3.0), results in an equivalent expression for work W, and change in kinetic energy ΔK, equal to the product of a proportionality constant ∝, and change in momentum ∫f(t)dt, multiplied by the average velocity v(t)av, where ∝=1 for any constant force F. In addition, if the force is constant then, the proportionality constant is ∝=1, and the work W, and change in kinetic energy ΔK, on any small interval xi and xf, equal to Δx, in the corresponding time-interval of ti to tf, equal to Δt, in which both xi and ti can be non-zero, and the limit of both Δx and Δt approach zero, is equal to the change in momentum ∫Fdt or the “impulse” of the force multiplied by the average velocity v(t)av, and where the average velocity v(t)av, approximately equals the instantaneous velocity v(t), as the limits of both Δx and Δt approach zero. As a result, the total change in kinetic energy ΔK, for any constant force F, on any limits of integration of xi=0 and xf, in the corresponding time-interval of ti=0 to tf, equals the sum of products of the product of the “impulse” of the force ∫Fdt, and the average velocity v(t)av, on the interval, seperated into smaller intervals, or Σ(∫Fdt)*v(t)av. When calculating work W, and change in kinetic energy ΔK, as the result of a constant force function F, on a limits of integration xi and xf, equal to Δx, in the corresponding time-interval ti to tf, equal to Δt, where both the initial distance xi and time tf can be non-zero, on any limits of integration, i.e., not only as the limits of integration Δx and Δt approach zero, the resulting energy can be calculated, using the transform function, and is exactly equal to the change in momentum Δm*v multiplied by the average velocity v(t)av or (∫f(t)dt)*v(t)av. However, if the force is time-varying f(t)=t, t², t³, . . . etc, then, the preceeding expression would include a variable proportionality constant for each small interval calculated, i.e., Σ∝(t)*(∫f(t)dt)*v(t)av, in order to calculate the total energy on some larger interval. If the force is time-varying, and the limits of integration are such that xi=0 and ti=0, then ∝=f(x)av/f(t)av is a rational-number and is constant on any interval of xi=0 and xf, in the corresponding time-interval of ti=0 to tf, equal to Δt, again when both xi=0 and ti=0, are zero, and thus W=∫f(x)dx=((1/Δx)*∫f(x)dx)*Δx=f(x)av*Δx=∝*f(t)av*Ax(tf)=(½)*m*v²(tf). A simple program written in basic language, is explained in the examples which follow, that allows the proportionality constants ∝=f(x)av/f(t)av, for single-term polynominals, to be determined on any limits of integration xi and xf, in the corresponding time-inteval ti to tf, equal to Δt. It will be shown how to use the proportionality constants ∝, for single-term polynominals, which make-up a multi-term polynominal force function such as f(t)=t²+t, in order to calculate work W, and change in kinetic energy ΔK, for an object or particle, in the form of W=(⅓)*t²f*[∝*( 1/12)*tf\hat{ }4+∝*(⅙)*t³f)+(½)*tf*[∝*( 1/12)*tf\hat{ }4+∝*(⅙)*t³f]=( 1/2)*m*v²(tf), which equate exactly to (½)*m*v²(tf), on any limits of integration xi=0 and xf, in the corresponding time-interval ti=0 to tf, equal to Δt, where both xi and ti are set equal to zero, again, when the force f(t), is a multi-term polynominal! For the purposes of explanation, the first example will involve a force f(x), as an equivalent function of time f(t), that can be referred to as a single-term polynominal, i.e., f(t)=t, f(t)=t², . . . etc. As an example, if f(t)=t, and the mass m, of an object is normalized to 1 kg, then using the transform function, we have the following in Eq. (4.0):

$$\begin{matrix}W = \int f ( x ) ⅆ x \\ = ∝ * [ \frac{1}{Δ t} * \int f ( t ) ⅆ t ] * \{ \int [ \int \frac{f ( t )}{m} ⅆ t ] ⅆ t \} \\ = ∝ * [ \frac{tf}{2} ] * \{ \frac{{t}^{3} f}{6} \} \\ = \frac{1}{2} * m * {v}^{2} ( tf )\end{matrix} \qquad Eq . ( 4.0 )$$

The work done W, by a time-varying force function f(t)=t, on an object of mass m, normalized to 1 kg, determined on a limits of integration xi=0 and xf, in the corresponding time-interval ti=0 to tf, equal to Δt, equals the product of a proportionality constant ∝=f(x)av/f(t)av, and the time-average of the force f(t)av=(1/Δt)*∫f(t)dt, multiplied by the change in distance Δx(tf)=∫[∫(f(t)/m)dt]dt, as shown in Eq. (4.0). The constant of proportionality ∝=f(x)av/f(t)av, in Eq. (4.0), equal to the ratio of f(x)av, to that of fx(t)av, which is equal to ratio of the average force f(x)av, as it varies over a distance xi=0 to xf, to that of the time-average f(t)av of the force f(t)=t, as it varies in the corresponding time-interval ti and tf, equal to Δt, in which both the initial displacement xi and time ti, must be set equal to zero, can be calculated using a simple basic language algorithm like the one given in the following below:

| 10 | CLS | |
|---|---|---|
| 20 | DEFDBL A-Z | |
| 30 | N= 0 | ; SET # OF F(X) VALUES TO ZERO |
| 40 | SUM = 0 | ; INITIALIZE RUNNING SUM OF F(X) VALUES |
| 50 | ti = 0 | |
| 60 | tf =0 | ; INITIALIZE TIME VALUES TO ZERO |
| 70 | dx = .001 | ; SET DIFFERENTIAL VALUE |

| | |
|---|---|
| 80 | DO UNTIL tf> 1 |

| 90 | tf = (6*dx + ti\hat{ }3)\hat{ }(1/3) | |
|---|---|---|
| 100 | SUM = SUM + tf | ; CALCULATE RUNNING SUM OF F(X) VALUES |

| | |
|---|---|
| 110 | ti = tf |
| 120 | N = N + 1 |

| 130 | LOOP | |
|---|---|---|
| 140 | PRINT : PRINT | |
| 150 | PRINT SUM/N | ; F(X)AV = AVERAGE IN TERMS OF DISTANCE |
| 160 | PRINT : PRINT | |
| 170 | PRINT TF/2 | ; F(T)AV = AVERAGE IN TERMS OF TIME |

| | | |
|---|---|---|
| 180 | PRINT (SUM/N)/(TF/2) | ; ∝= F(X)AV/F(T)AV = 1.5 = PROPORTIONALITY CONSTANT |

| | |
|---|---|
| 190 | END |

A proportionality constant ∝=f(x)av/f(t)av, for any single-term polynominal t, t², . . . etc, is constant on any limits of integration xi=0 and xf, in the corresponding time-interval ti=0 to tf, equal to Δt, in which both xi, and ti are initialized to zero. In the above example program, the time-interval ti=0 to tf=1, is equal to one-second Δt=1s, the resulting displacement is Δx(tf)=∫[∫(f(t)/m)dt]dt=t³f/6=⅙, and the proportionality constant is ∝=f(x)av/f(t)av=1.5, in which the force function is such that f(t)=t, and the mass is m=1 kg. The proportionality constant ∝=f(x)av/f(t)av=1.5, determined in the above program, for a given force function f(t)=t, and m=1 kg, is the same on any interval xi=0 to xf, in the corresponding time-interval ti=0 to tf, equal to Δt=tf−ti, regardless of the final values for xf and tf. As a result, using the transform function, the work W=∫f(x)dx=∝*[(1/Δt)*∫f(t)dt]*{∫[∫(f(t)/m)dt]dt}=(½)*m*v²(tf), and change in kinetic AK energy, for any object or particle on a limits of integration of xi=0 and xf, in the corresponding time-interval ti=0 to tf equal to Δt, where both xi and ti are initialized to zero, due to a force function f(t), that is constant F or a single-term polynominal t, t², . . . etc., can be calculated, equal to the product of a proportionality constant ∝=f(x)av/f(t)av, and the time-average of the force function f(t)av, multiplied by the change in distance Δx(tf), as shown in general in Eq. (3.0), and specifically for f(t)=t in Eq. (4.0), and ∝=1 for any constant force F. Multiplying both numerator and denominator of the preceeding expression by Δt, results in an equivalent expression equal to the product of the proportionality constant ∝ and the change in momentum, multiplied by the average velocity v(t)av. The constant of proportionality ∝=f(x)av/f(t)av, can be calculated using the algorithm, written in basic language, given above, for any force function f(t) that is a single-term polynominal t, t², . . . etc. All that needs to be done is to substitute the appropriate variables for the force function f(t)=t, t², . . . , and the corresponding displacement function Δx(tf)=t³/m*6, t\hat{ }4/m*12 . . . , in the above program. For the example above f(t)=t, and ∝=f(x)av/f(t)av=1.5, allowing work W=∝*[tf/2]*{t³f/6}=(½)*m*v²(tf), and change in kinetic energy ΔK, to be calculated as function of time, using Eq. (4.0), on any limits of integration of xi=0 and xf, in the corresponding time-interval ti=0 to tf, equal to Δt, in which both xi anf ti, are initialized to zero. Substitution of any final time values tf, in Eq. (4.0), results in a calculated work W, and change in kinetic energy ΔK, exactly equal to (½)*m*v²(tf), as indicated in the last expression in Eq. (4.0). The results can be quickly verified by substituting any value for tf, in Eq. (4.0), using ∝=1.5 for the transform function, determining the resulting final velocity v(tf), then calculating (½)*m*v²(tf), and comparing results. They are exactly equivalent! The final velocity vf, as a function of time, can be derived from the indefinite integral v(t)=∫(f(t)/m)dt=∫(f(t)dt. The velocity as a function of time v(t), in Eq. (4.0), at any final value of time tf, equals v(tf)=t²f/2. In the following Eq. (5.0), the calculated work W=∫f(x)dx=∝*[(1/Δt)*∫f(t)dt]*{∫[∫(f(t)/m)dt]dt=(½)*m*v²(tf), and change in kinetic energy ΔK, for an object or particle of mass m=1 kg, due to two force functions f(t)=t² and f(t)=t³, along with thier corresponding proportionality constants ∝, are given for reference:

$$\begin{matrix}W = \int f ( x ) ⅆ x \\ = ∝ * [ ( \frac{1}{Δ t} ) * \int f ( t ) ⅆ t ] * \{ \int [ \int \frac{f ( t )}{m} ⅆ t ] ⅆ t \} \\ = 2 * [ \frac{{t}^{2} f}{3} ] * \{ \frac{t f \hat{} 4}{12} \} \\ = ( \frac{1}{2} ) * m * {v}^{2} ( tf ) \\ W = \int f ( x ) ⅆ x \\ = ∝ * [ ( \frac{1}{Δ t} ) * \int f ( t ) ⅆ t ] * \{ \int [ \int \frac{f ( t )}{m} ⅆ t ] ⅆ t \} \\ = 2.5 * [ \frac{{tf}^{3}}{4} ] * \{ \frac{t f \hat{} 5}{20} \} \\ = ( \frac{1}{2} ) * m * {v}^{2} ( tf )\end{matrix} \qquad Eq . ( 5.0 )$$

The resulting work done W, on an object or particle, due to two force functions f(t)=t², and f(t)=t³, in Eq. (5.0), determined on a limits of integration of xi and xf, in the corresponding time-intervals ti to tf, equal to Δt, in which both ti and and xi are initialized to zero, using the transform function, exactly equals the product of the time-average of the force function f(t)av, and the proportionality constant ∝=f(x)av/f(t)av, multiplied by the change in distance Δx(tf)=∫v(t)dt. Note the substitution of the actual proportionality constants ∝=2, and ∝=2.5, in Eq. (5.0). The calculation of the actual proportionality constants ∝=2, and ∝=2.5, for f(t)=t², and f(t)=t³, were determined using the following programs given below for reference:

| 10 | CLS | |
|---|---|---|
| 20 | DEFDBL A-Z | |
| 30 | N= 0 | ; SET # OF F(X) VALUES TO ZERO |
| 40 | SUM = 0 | ; INITIALIZE RUNNING SUM OF F(X) VALUES |
| 50 | ti = 0 | |
| 60 | tf =0 | ; INITIALIZE TIME VALUES TO ZERO |
| 70 | dx = .001 | ; SET DIFFERENTIAL VALUE |

| | |
|---|---|
| 80 | DO UNTIL tf> 1 |

| 90 | tf = (12*dx + ti\hat{ }4)\hat{ }(1/4) | |
|---|---|---|
| 100 | SUM = SUM + t²f | ; CALCULATE RUNNING SUM OF F(X) VALUES |

| | |
|---|---|
| 110 | ti = tf |
| 120 | N = N + 1 |

| 130 | LOOP | |
|---|---|---|
| 140 | PRINT : PRINT | |
| 150 | PRINT SUM/N | ; F(X)AV = AVERAGE IN TERMS OF DISTANCE |
| 160 | PRINT : PRINT | |
| 170 | PRINT T²F/3 | ; F(T)AV = AVERAGE IN TERMS OF TIME |

| | | |
|---|---|---|
| 180 | PRINT (SUM/N)/(T²F/3) | ; ∝= F(X)AV/F(T)AV = 2 = PROPORTIONALITY CONSTANT |
| 190 | END | |
| 10 | CLS | |
| 20 | DEFDBL A-Z | |

| | | |
|---|---|---|
| 30 | N= 0 | ; SET # OF F(X) VALUES TO ZERO |
| 40 | SUM = 0 | ; INITIALIZE RUNNING SUM OF F(X) VALUES |
| 50 | ti = 0 | |
| 60 | tf =0 | ; INITIALIZE TIME VALUES TO ZERO |
| 70 | dx = .001 | ; SET DIFFERENTIAL VALUE |

| | |
|---|---|
| 80 | DO UNTIL tf> 1 |

| 90 | tf = (20*dx + ti\hat{ }5)\hat{ }(1/5) | |
|---|---|---|
| 100 | SUM = SUM + t³f | ; CALCULATE RUNNING SUM OF F(X) VALUES |

| | |
|---|---|
| 110 | ti = tf |
| 120 | N = N + 1 |

| 130 | LOOP | |
|---|---|---|
| 140 | PRINT : PRINT | |
| 150 | PRINT SUM/N | ; F(X)AV = AVERAGE IN TERMS OF DISTANCE |
| 160 | PRINT : PRINT | |
| 170 | PRINT T³F/4 | ; F(T)AV = AVERAGE IN TERMS OF TIME |

| | | |
|---|---|---|
| 180 | PRINT (SUM/N)/(T³F/4) | ; ∝= F(X)AV/F(T)AV = 2.5 = PROPORTIONALITY CONSTANT |

| | |
|---|---|
| 190 | END |

To calculate the work done W, and change in kinetic energy ΔK, of an object or particle of mass m, due to a force function f(t), that is a single-term polynominal f(t)=t, f(t)=t² . . . , on a limits of integration xi and xf; in the corresponding time-interval ti to tf; equal to Δt, when both xi and ti are nonzero, the work done W, by the force f(t), can be determined on seperate intervals consisting of the work W=(½)*m*v²(tf1), calculated on an interval xi=0 to xf1 with a corresponding final velocity v(tf1), in a time-interval of ti=0 to tf1, equal to Δtf1, and on a second interval consisting of the work W=(½)*m*v²(tf2), calculated on a limits of integration xi=0 and xf2, with a corresponding final velocity v(tf2), in a time-interval of ti=0 to tf2, equal to Δtf2. The resulting work done W, and change in kinetic energy ΔK, equals the difference between one-half of the product of the mass m, of the object or particle, and the square of the final and initial velocities, equal to the difference between the two energies, calculated on the seperate intervals, as given in the following Eq. (6.0):

$$\begin{matrix}W = \int f ( x ) ⅆ x - \int f ( x ) ⅆ x \\ = ∝ * [ ( \frac{1}{Δ t} ) * \int f ( t ) ⅆ t ] * \{ \int [ \int \frac{f ( t )}{m} ⅆ t ] ⅆ t \} - \\ ∝ * [ ( \frac{1}{Δ t} ) * \int f ( t ) ⅆ t ] * \{ \int [ \int ( \frac{f ( t ) )}{m} ⅆ t ] ⅆ t \} \\ = ( \frac{1}{2} ) * m * {v}^{2} ( tf2 ) - ( \frac{1}{2} ) * m * {v}^{2} ( tf1 )\end{matrix} \qquad Eq . ( 6.0 )$$

In order to calculate the work done W=(½)*m*v²(tf), and change in kinetic energy ΔK, in integral form, when the force as an equivalent function of time, is a multi-term polynominal, i.e., f(t)=t²+t, f(t)=t³+t, f(t)=t²+t−1 . . . etc., the transform function can be used. When the force function f(t), that does work W=(½)*m*v²(tf), on an object or particle of mass m, is a multi-term polynominal equal to t³+t²+t, the area under the curve for the force f(t), versus the displacement Δx(tf), equal to the work done W=(½)*m*v²(tf), and change in kinetic energy ΔK, of the object or particle, can be calculated using the expression given in the following Eq. (7.0):

$$\begin{matrix}W = \int f ( x ) ⅆ x \\ = ( \frac{{t}^{3} f}{4} ) * ( ∝ 3 * \frac{t f \hat{} 5}{20} + ∝ 2 * \frac{t f \hat{} 4}{12} + ∝ 1 * \frac{{t}^{3} f}{6} ) + \\ ( \frac{{t}^{2} f}{3} ) * ( ∝ 3 * \frac{t f \hat{} 5}{20} + ∝ 2 * \frac{t f \hat{} 4}{12} + ∝ 1 * \frac{{t}^{3} f}{6} ) + \\ ( \frac{t f}{2} ) * ( ∝ 3 * \frac{t f \hat{} 5}{20} + ∝ 2 * \frac{t f \hat{} 4}{2} + ∝ 1 * \frac{{t}^{3} f}{6} ) \\ = [ ∝ 3 * ( \frac{{t}^{3} f}{4} ) + ∝ 2 * ( \frac{{t}^{2} f}{3} ) + ∝ 1 * ( \frac{t f}{2} ) ] * \frac{t f \hat{} 5}{20} + \\ [ ∝ 3 * ( \frac{{t}^{3} f}{4} ) + ∝ 2 * ( \frac{{t}^{2} f}{3} ) + ∝ 1 * ( \frac{t f}{2} ) ] * \frac{t f \hat{} 4}{12} + \\ [ ∝ 3 * ( \frac{{t}^{3} f}{4} ) + ∝ 2 * ( \frac{{t}^{2} f}{3} ) + ∝ 1 * ( \frac{t f}{2} ) ] * \frac{{t}^{3} f}{6} + \\ = [ f ( x ) 3 av + f ( x ) 2 av + f ( x ) 1 av ] * Δ x3 + \\ [ f ( x ) 3 av + f ( x ) 2 av + f ( x ) 1 av ] * Δ x2 + \\ [ f ( x ) 3 av + f ( x ) 2 av + f ( x ) 1 av ] * Δ x1 \\ = \int [ f ( x ) 3 + f ( x ) 2 + f ( x ) 1 ] ⅆ x3 + \\ \int [ f ( x ) 3 + f ( x ) 2 + f ( x ) 1 ] ⅆ x2 + \\ \int [ f ( x ) 3 + f ( x ) 2 + f ( x ) 1 ] ⅆ x1 \\ = \frac{1}{2} * m * {v}^{2} ( tf )\end{matrix} \qquad Eq . ( 7.0 )$$

Eq. (7.0) is an expression for work W, and change in kinetic energy ΔK, of an object or particle, when the force f(t), that does work W=(½)*m*v₂(tf), on the object or particle, is a multi-term polynominal f(t)=t²+t, f(t)=t³+t−1 . . . etc., and for the example in Eq. (7.0), f(t)=t³+t²+t, where m=1 kg. In general any force function f(t), can be expressed in the form of an equivalent maclaurin series consisting of a series of single polynominal terms, and the basic force function, which is a simple multi-term polynominal force function consisting of single-term polynominals, f(t)=t³+t²+t, was used in Eq. (7.0), for simplicity. An example which utillizes an actual maclaurin series to calculate the area under the curve for a parametric function in two dimensions involving rectilinear motion of a mass which moves in a circle, is given in the example in Eq. (12.0). The work done W, and change in kinetic energy ΔK, for an object or particle of mass m, due to a force function f(t), that is a multi-term polynominal which does work W=(½)*m*v²(tf), on the object or particle, in Eq. (7.0), is calculated on a limits of integration of xi=0 and xf, in the corresponding time-interval ti=0 to tf, equal to Δt, where both xi and ti are initialized to zero. The area under the curve for a multi-term polynominal force function f(t)=t³+t²+t, versus the displacement Δx(tf), is calculated using a product of the time-average of the force f(t)av, and the change in distance Δx(tf), in addition to the proportionality constants ∝1, ∝2, ∝3, . . . , as shown in the first and second right-hand expressions in Eq. (7.0). The third and fourth right-hand expressions in Eq. (7.0), indicate the work W, and change in kinetic energy ΔK, for an object or particle of mass m, due to a force function f(t), that is a multi-term polynominal, after rearranging terms, can be expressed in special integral form which combines the sum of products of each time-average integrand term and it's corresponding proportionality constant for a particular differential term of the displacement for each corresponding differential term that makes up the total displacement Δx(tf), giving three seperate integral functions, which exactly equates to (½)*m*v²(tf), as is the case with single-term polynominal force functions explained before above, it's just that there are three integral functions instead of one. To clarify how to calculate the work W, and change in kinetic energy ΔK, when the force f(t), that does work W, on an object or particle, is a multi-term polynominal, expressed in the form of an equivalent maclaurin series, using the transform function, the process, using an example force function f(t)=t³+t²+t and m=1 kg, is shown in four steps in the following Eq. (8.0):

$$1 \text{:} f ( tf ) av = \frac{{t}^{3} f}{4} + \frac{{t}^{2} f}{3} + \frac{tf}{2} , Δ x ( tf ) = 3 * \frac{tf \hat{} 5}{20} + 2 * \frac{tf \hat{} 4}{12} + \frac{{t}^{3} f}{6} \\ 2 \text{:} f ( tf ) av * Δ x ( tf ) = ( \frac{{t}^{3} f}{4} + \frac{{t}^{2} f}{3} + \frac{tf}{2} ) * ( \frac{tf \hat{} 5}{20} + \frac{tf \hat{} 4}{12} + \frac{{t}^{3} f}{6} ) 3 \text{:} ( \frac{{t}^{3} f}{4} ) * ( \frac{tf \hat{} 5}{20} + \frac{tf \hat{} 4}{12} + \frac{{t}^{3} f}{6} ) + ( \frac{{t}^{2} f}{3} ) * ( \frac{tf \hat{} 5}{20} + \frac{tf \hat{} 4}{12} + \frac{{t}^{3} f}{6} ) + ( \frac{tf}{2} ) * ( \frac{tf \hat{} 5}{20} + \frac{tf \hat{} 4}{12} + \frac{{t}^{3} f}{6} ) = [ \frac{{t}^{3} f}{4} + \frac{{t}^{2} f}{3} + \frac{tf}{2} ] * \frac{tf \hat{} 5}{20} + [ \frac{{t}^{3} f}{4} + \frac{{t}^{2} f}{3} + \frac{tf}{2} ] * \frac{tf \hat{} 4}{12} + [ \frac{{t}^{3} f}{4} + \frac{{t}^{2} f}{3} + \frac{tf}{2} ] * \frac{{t}^{3} f}{6} \\ 4 \text{:} ( \frac{{t}^{3} f}{4} ) * ( ∝ 33 * \frac{tf \hat{} 5}{20} + ∝ 32 * \frac{tf \hat{} 4}{12} + ∝ 31 * \frac{{t}^{3} f}{6} ) + ( \frac{{t}^{2} f}{3} ) * ( ∝ 23 * \frac{tf \hat{} 5}{20} + ∝ 22 * \frac{tf \hat{} 4}{12} + ∝ 21 * \frac{{t}^{3} f}{6} ) + ( \frac{tf}{2} ) * ( ∝ 13 * \frac{tf \hat{} 5}{20} + ∝ 12 * \frac{tf \hat{} 4}{12} + ∝ 11 * \frac{{t}^{3} f}{6} ) = [ ∝ 33 * \frac{{t}^{3} f}{4} + ∝ 23 * \frac{{t}^{2} f}{3} + ∝ 13 * \frac{tf}{2} ] * \frac{tf \hat{} 5}{20} + [ ∝ 32 * \frac{{t}^{3} f}{4} + ∝ 22 * \frac{{t}^{2} f}{3} + ∝ 12 * \frac{tf}{2} ] * \frac{tf \hat{} 4}{12} + [ ∝ 31 * ( \frac{{t}^{3} f}{4} + ∝ 21 * \frac{{t}^{2} f}{3} + ∝ 11 * \frac{tf}{2} ] * \frac{{t}^{3} f}{6} = [ f ( x ) 3 av + f ( x ) 2 av + f ( x ) 1 av ] * Δ x3 + [ f ( x ) 3 av + f ( x ) 2 av + f ( x ) 1 av ] * Δ x2 + [ f ( x ) 3 av + f ( x ) 2 av + f ( x ) 1 av ] * Δ x1 = \int [ f ( x ) 3 + f ( x ) 2 + f ( x ) 1 ] ⅆ x3 + \int [ f ( x ) 3 + f ( x ) 2 + f ( x ) 1 ] ⅆ x2 + \int [ f ( x ) 3 + f ( x ) 2 + f ( x ) 1 ] ⅆ x1 = [ 2.5 * \frac{{t}^{3} f}{4} + 2.143 * \frac{{t}^{2} f}{3} + 1.667 * \frac{tf}{2} ] * \frac{tf \hat{} 5}{20} + [ 2.286 * \frac{{t}^{3} f}{4} + 2 * \frac{{t}^{2} f}{3} + 1.6 * \frac{tf}{2} ] * \frac{tf \hat{} 4}{12} + [ 2 * \frac{{t}^{3} f}{4} + 1.8 * \frac{{t}^{2} f}{3} + 1.5 * \frac{tf}{2} ] * \frac{{t}^{3} f}{6} = \frac{1}{2} * m * {v}^{2} ( tf ) \qquad Eq . ( 8.0 )$$

The first step 1, above in Eq. (8.0), involves determining the time-average of the force function f(t)av=(1/Δt)*∫f(t)dt=t³f/4+t²f/3+tf/2, and the corresponding change in distance Δx(tf)=3*tf\hat{ } 5/20+2*tf\hat{ } 4/12+t³f/6, in a time-interval of ti=0 to tf, equal to Δt. In the second step 2, the product of the time-average of the force f(t)av, and the change in distance Δx(tf), are determined. The third step 3 involves expanding the product in step 2, into the sum of products of the individual polynominal terms for the time-average of the force f(t)av, and the sum of the individual polynominal terms for the change in distance Δx(tf), as shown in the first right-hand expression in step 3, and then rearranging terms using the commutative and associative properties, to give the sum of products of the sum for the individual terms which make up the time-average of the force f(t)av, and each individual term that makes up the displacement Δx(tf), as shown in the last expression in step 3. The last step 4 involves determining the proportionality constants ∝33, ∝23, ∝13, . . . etc. The proportionality constants ∝33, ∝23, ∝13, . . . etc, in Eq. (8.0), step 4, for each single polynominal term for the time-average of the force function f(t)av, determined in terms of each single polynominal term that make up the change in distance Δx(tf), can be calculated with the programs given before above. Please note that some proportionality constants ∝n, determined using the above programs, were rounded to three decimal places to save computation time. Specifically, the proportionality constants ∝33=2.5, ∝32=2.286, ∝31=2, ∝23=2.143, ∝22=2, ∝21=1.8, ∝13=1.667, ∝12=1.6, ∝11=1.5, were determined by calculating the ratios for the average of the individual polynominal terms that make-up the force function f(x)av, in terms of distance, as calculated in terms of the single polynominal terms which make-up the force function t³f, t²f, tf, and the change in distance Δx3(tf)=tf\hat{ } 5/20, Δx²(ft)=tf\hat{ } 4/12, Δx1(tf)=t³f/6, to that of the time-average for the single polynominal terms which make-up the force function f3(t)av=(t³f/4), f2(t)av=(t²f/3), f1(t)av=(tf/2), using the progams given before above for single-term polynominals. As a result, the second to last expression in step 4, of Eq. (8.0), can be used to calculate the area under the curve for a force function f(t)=t³+t²+t, that is a multi-term polynominal, in terms of the displacement ≢x(tf), as an equivalent function of time, equal to the work done W=(½)*m*v²(tf), and change in kinetic energy ΔK, of an object or particle of mass m=1 kg, on a limits of integration xi=0 and xf, in the corresponding time-interval ti to tf equal to Δt, where both xi and ti must be set equal to zero.

The expression given in the following Eq. (9.0), can used to calculate work W=(½)*m*v²(tf), and change in kinetic energy ΔK, for an object or particle of mass m=1 kg, due to a force function f(t)=t²−t:

$$\begin{matrix}W = ( \frac{{t}^{2} f}{3} ) * ( ∝ 22 * \frac{tf \hat{} 4}{12} - ∝ 21 * \frac{{t}^{3} f}{6} ) - \\ ( \frac{tf}{2} ) * ( ∝ 12 * \frac{tf \hat{} 4}{12} - ∝ 11 * \frac{{t}^{3} f}{6} ) \\ = ( ∝ 22 * \frac{{t}^{2} f}{3} - ∝ 12 * \frac{tf}{2} ) * \frac{tf \hat{} 4}{12} - \\ ( ∝ 21 * \frac{{t}^{2} f}{3} - ∝ 11 * \frac{tf}{2} ) * \frac{{t}^{3} f}{6} \\ = ( f2 ( x ) av - f1 ( x ) av ) * Δ x2 - ( f2 ( x ) av - f1 ( x ) av ) * Δ x1 \\ = \int ( f2 ( x ) - f1 ( x ) ) ⅆ x2 - \int ( f2 ( x ) av - f1 ( x ) av ) ⅆ x1 \\ = ( 2 * \frac{{t}^{2} f}{3} - 1.6 * \frac{tf}{2} ) * \frac{tf \hat{} 4}{12} - \\ ( 1.8 * \frac{{t}^{2} f}{3} - 1.5 * \frac{tf}{2} ) * \frac{{t}^{3} f}{6} \\ = \frac{1}{2} * m * {v}^{2} ( tf )\end{matrix} \qquad Eq . ( 9.0 )$$

Using Eq. (9.0), the work W=(½)*m*v²(tf), and change in kinetic energy ΔK, can be determined on any limits of integration xi=0 and xf, in any corresponding time-interval ti=0 to tf, equal to Δt, where both the initial displacement xi, and time ti, must be set equal to zero. The last expression in Eq. (9.0), indicates that the work done W, by a force function f(t)=t²−t, and the resulting change in kinetic energy ΔK, of an object or particle of mass m=1 kg, determined on a limits of integration xi=0 and xf, in the corresponding time-interval ti=0 to tf equal to Δt, where both xi and ti are initialized to zero, exactly equals (½)*m*v²(tf). Note in Eq. (8.0), the substitution of the actual proportionality constants ∝n, into the expression, in the next to last expression. The proportionality constants were calculated using the algorithms written in basic language, given before above. As it turns out, the proportionality constants ∝n, are all round numbers, and as a result there is no need to truncate any of the proportionality contants to a significant number of decimal places, as was done in Eq. (8.0), in order to save on the amount of required computation time using the programs above. For the example in Eq. (9.0), f(t)=t²−t, Δx(tf)=t\hat{ } 4/12−t³/6, and ∝22=2, ∝21=1.8, ∝12=1.6, ∝11=1.5, allowing work W, and change in kinetic energy ΔK, to be calculated, as function of time t, on any limits of integration xi=0 and xi, in the corresponding time-interval ti=0 to ti, equal to Δt, in which both xi anf ti are set equal to zero. Substitution for any final time-value tf in Eq (9.0), results in a calculated W, and change in kinetic energy ΔK, exactly equal to (½)*m*v²(tf), as indicated in the last expression. The results can be quickly verified, using a calculator, by substituting any value for tf, in Eq. (8.0) or (9.0), then determining the final velocity v(tf), and using (½)*m*v²(tf), and then comparing results. They are exactly the same (and only to a few decimal places in Eq. (9.0) since some proportionality constants were rounded)! The final velocity v(tf), as a function of a final time tf, can be derived from the indefinite integral v(t)=∫(f(t)/m)dt=∫a(t)dt, and the final velocity v(tf), in Eq. (9.0), at any final value of time tf, is equal to v(tf)=t³f/3−t²f/2. The areas under the curves for the force functions f(t)=t³+t²+t, and f(t)=t²−t, in Eq. (8.0) and (9.0), as they vary with respect to distance Δx(t), i.e., ∫f(x)dx, can also be verified using the trapezoid rule and a basic language program, as given in the following:

| 10 | CLS | |
|---|---|---|
| 20 | DEFDBL A- Z | ; FLOATING POINT DOUBLE PRECISION |

| | | |
|---|---|---|
| 30 | TI = 0 | ; INITIALIZE TIME VALUES |
| 40 | TF = 0 | |
| 50 | M = 1 | ;SET MASS M =1 KILOGRAM |
| 60 | DX = 0 | ;SET INITIAL DIFFERENTIAL VALUE |
| 70 | SUM = 0 | ; INITALIZE TOTAL AREA |

| | |
|---|---|
| 80 | DO UNTIL TF >20 |

| 90 | DX = Tf\hat{ }5/20 + Tf\hat{ }4f/12+ T³f/6 − (Ti\hat{ }5/20 + Ti\hat{ }4f/12+ T³i/6 ) ;CALCULATE DIFFERENTIAL DX | |
|---|---|---|
| 100 | AREA = [(T³f + T²f + Tf) + (T³i + T²i + Ti)] *DX / 2 | ;DETERMINE TRAPEZOID AREAS |

| | | |
|---|---|---|
| 110 | SUM = SUM + AREA | ;CALCULATE TOTAL AREA |
| 120 | TI = TF : TF = TF + .001 | ;UPDATE TIME VALUES |

| 130 | LOOP | |
|---|---|---|
| 140 | PRINT SUM | ;PRINT AREA UNDER CURVE FOR F(X) |
| 150 | PRINT (1/2) *M* (Tf\hat{ }4 / 4 + T³f/3 + T²f/2)² | ;PRINT KINETIC ENERGY (1/2)*M*V²(Tf) |
| 160 | END | |
| 10 | CLS | |
| 20 | DEFDBL A-Z | ;FLOATING POINT DOUBLE PRECISION |

| | | |
|---|---|---|
| 30 | TF = 20 | ;SET FINAL TIME TF TO 20 SECONDS |

| 40 | A = (T³f/4)*(2.5*tf\hat{ }5/20 + 2.286*Tf\hat{ }4/12 + 2*T³f/6) | ;CALCULATE AREA UNDER CURVE |
|---|---|---|
| | + (T²f/3)*(2.143*Tf\hat{ }5/20 + 2*Tf\hat{ }4/12 + 1.8*T³f/6) | ;USING TRANSFORM FUNCTION |

| | + (Tf/2)*(1.67*Tf\hat{ }5/20 + 1.6*Tf\hat{ }4/12 + 1.5*T³f/6) | |
|---|---|---|
| 50 | PRINT: PRINT A; | |
| 60 | K = (1/2) *M* (Tf\hat{ }4 / 4 + T³f/3 + T²f/2)² | ;CALCULATE KINETIC ENERGY (1/2)*M*V²(Tf) |
| 70 | PRINT: PRINT K; | |
| 80 | END | |
| 10 | CLS | |

| | | |
|---|---|---|
| 20 | DEFDBL A- Z | ;FLOATING POINT DOUBLE PRECISION |

| | | |
|---|---|---|
| 30 | TI= 0 | ;INITIALIZE TIME VALUES |
| 40 | TF = 0 | |
| 50 | M = 1 | ;SET MASS M = 1 KILOGRAM |
| 60 | DX = 0 | |
| 70 | SUM = 0 | ;INITIALIZE TOTAL AREA |
| 80 | DO UNTIL TF >20 | |

| | | |
|---|---|---|
| 90 | DX = (T\hat{ }4f/12 − T³f/6) − (TI\hat{ }4/12 + T³I/6) | ;CALCULATE DIFFERENTIAL DX |
| 100 | AREA = [(T²f − Tf) + (T²i − Ti)] *DX / 2 | ;DETERMINE TRAPEZOID AREAS |
| 110 | SUM = SUM + AREA | ;CALCULATE TOTAL AREA |
| 120 | TI = TF : TF = TF + .001 | ;UPDATE TIME VALUES |

| 130 | LOOP | |
|---|---|---|
| 140 | PRINT SUM | ;PRINT AREA UNDER CURVE FOR F(X) |
| 150 | PRINT (1/2) *M* (T³f / 3 − T²f / 2)² | ;PRINT KINETIC ENERGY (1/2)*M*V²(Tf) |
| 160 | END | |
| 10 | CLS | |

| | | |
|---|---|---|
| 20 | DEFDBL A-Z | ;FLOATING POINT DOUBLE |

| | PRECISION | |
|---|---|---|
| 30 | TF= 20 | ;SET FINAL TIME TF TO 20 SECONDS |

| | | |
|---|---|---|
| 40 | M = 1 | ; SET MASS M = 1 KILOGRAM |

| 50 | A = (T²f/3)*(2*Tf\hat{ }4/12 − 1.8*T³f/6) | ;CALCULATE AREA UNDER CURVE |
|---|---|---|
| | − (Tf/2)*(1.6*Tf\hat{ }4/12 − 1.5*T³f/6) | ;USING TRANSFORM FUNCTION |

| 60 | PRINT: PRINT A; | |
|---|---|---|
| 70 | K = (1/2) *M* (T³f/3 − T²F/2)² | ;CALCULATE KINETIC ENERGY (1/2)*M*V²(Tf) |
| 80 | PRINT: PRINT K; | |
| 90 | END | |

The above basic language programs determine the areas under the curves, using the trapezoid rule, for the force functions f(t)=t³+t²+t, and f(t)=t²−t, on a limits of integration of xi=0 and xf=174666.67, and xi=0 and xf=12000, respectively, in corresponding time-intervals of ti=0 to tf=20. The results are then compared to the area ∫f(x)dx as determined using the transform function and (½)*m*v²(tf), to show that they are equivalent. Please note again, that some proportionality constants ∝n, given in Eq. (8.0), had to be rounded off in order to reduce computation time, and as a result, the calculated area using the transform function for f(t)=t³+t²+t, is only accurate to a few decimal places. By calculating the proportionality constants ∝n, for f(t)=t³+t²+t, to more decimal places (which can take a considerble amount of computation time), the calculated area using the transform function will be more accurate.

In order to calculate the work done W, and change in kinetic energy ΔK, of an object or particle of mass m, due to a force function f(t), that is a multi-term polynominal t²+t, t\hat{ }4+t²+t . . . etc., determined on a limits of integration xi and xf, in the corresponding time-interval tf to tf, equal to Δt, when both xi, and ti are nonzero, work W, calculated using the transform function, must be determined on two seperate intervals. The work done W, by the force f(t), can be calculated on seperate intervals consisting of the work W=(½)*m*v²(tf2), on an interval xi=0 to Δx(tf2), with a velocity v(tf2), in a corresponding time-interval ti=0 to tf2, equal to Δtf2, and the work W=(½)*m*v²(tf1), on another interval xi=0 to Δx(tf1), with a velocity v(tf1), in a corresponding time-interval ti=0 to tf1, equal to Δtf1. The resulting work W, and change in kinetic energy ΔK, on a limits of integration xi and xf, in the corresponding time-interval ti to tf, equal to Δt, in which both ti and xi are nonzero, equals the difference between one-half of the product of the mass m, of the object or particle, and square of the final and initial velocities, i.e., W=(½)*m*v²(tf2)−(½)*m*v²(tf1).

In addition, please note that the proportionality constants ∝n, again, are rational numbers, which are the same for any combination of two single-term polynominals i.e., t² and t, t³ and t², etc.! As a result, an array of proportionality constants ∝n, can be constructed as an array table in order to quickly access the proportionality constants ∝n, used with the transform function, to calculate the integral area for any integrand variable fy(t), and or the vector component(s) of fy(t), in terms of some differential variable fx(t), where both fy(t) and fx(t) can be constant, single or multi-term polynominal variables!

1. Using the transform function with an array table, consisting of array values for proportionality constants ∝n (rational numbers specified to sixteen or more decimal places!), in order to calculate the integral area under the curve for the vector component(s) of some integrand polynominal fy(t), as a function of some differential polynominal fx(t), to within an accuracy of sixteen or more decimal places, is extremely faster than the trapezoid method for determining the integral area under the curve.
